(19) United States
(12) Patent Application Publication
(10) Pub. No.: US 2025/0285339 A1
(43) Pub. Date: Sep. 11, 2025

(54) ELECTRONIC DEVICE, METHOD, AND NON-TRANSITORY, COMPUTER-READABLE STORAGE MEDIUM FOR GENERATING AERIAL VIEW OF VEHICLE BASED ON LOCATIONS OF CAMERAS

(71) Applicant: THINKWARE CORPORATION, Seongnam-si (KR)

(72) Inventors: Sukpil KO, Seongnam-si (KR); Taekyun KIM, Seongnam-si (KR)

(21) Appl. No.: 19/073,079

(22) Filed: Mar. 7, 2025

(30) Foreign Application Priority Data
Mar. 7, 2024 (KR) 10-2024-0032558

(51) Int. Cl. G06T 11/00; B60R 1/27; H04N 7/18

(52) U.S. Cl. CPC G06T 11/00; B60R 1/27; H04N 7/181; B60R 2300/105; B60R 2300/303; B60R 2300/802

(57) ABSTRACT

An electronic device of a vehicle. The device obtains first images of cameras. The cameras may be respectively positioned on portions of the vehicle rotatably coupled to each other. The device transmits, to a display connected through the communication interface, a first composite image which is composited to provide an aerial view of the vehicle at a first moment when the first images were obtained. The device, when synthesizing second images obtained from the cameras at a second moment after the first moment, determines, using locations of the cameras at the second moment, whether a second composite image to which the second images are composited includes a blind area. The device, based on determining that the second composite image includes the blind area, transmits, to the display, the second composite image with which a portion of the first composite image corresponding to the blind area is combined.

### CROSS-REFERENCE TO RELATED APPLICATION(S)

This application is a based on and claims priority under 35 U.S.C. § 119 to Korean Patent Application No. 10-2024-0032558, filed on Mar. 7, 2024, in the Korean Intellectual Property Office, the disclosures of which is incorporated by reference herein in their entirety.

### BACKGROUND

### Field

The disclosure relates to an electronic device, method, and non-transitory, computer-readable storage medium for generating an aerial view for a vehicle based on locations of cameras.

### Description of Related Art

A vehicle may include electronic components (e.g., an electronic control unit (ECU)) to assist the driver's driving activities. The electronic components may include a camera for obtaining images and/or videos of the external environment of the vehicle. The electronic components may include a display for visualizing information related to the vehicle.

The above-described information may be provided as related art for the purpose of helping understanding of the disclosure. The foregoing cannot be claimed as, or used to determine, the prior art related to the disclosure.

### SUMMARY

In an embodiment, there may be provided an electronic device of a vehicle. The electronic device may comprise memory storing instructions, a communication interface, and a processor. The instructions may, when executed by the processor, cause the electronic device to obtain first images of cameras through the communication interface. The cameras may be respectively positioned on portions of the vehicle rotatably coupled to each other. The instructions may, when executed by the processor, cause the electronic device to transmit, to the display connected through the communication interface, a first composite image which is composited to provide an aerial view of the vehicle at a first moment when the first images were obtained. The instructions may, when executed by the processor, cause the electronic device to, when synthesizing second images obtained from the cameras at a second moment after the first moment, determine, using locations of the cameras at the second moment, whether a second composite image to which the second images are composited includes a blind area. The instructions may, when executed by the processor, cause the electronic device to, based on determining that the second composite image includes the blind area, transmit, to the display, the second composite image with which a portion of the first composite image corresponding to the blind area is combined.

In an embodiment, there may be provided a method of an electronic device of a vehicle. The method may comprise obtaining first images of cameras through a communication image frame. The cameras may be respectively positioned on portions of the vehicle rotatably coupled to each other. The method may comprise transmitting, to a display connected through the communication interface, a first composite image which is composited to provide an aerial view of the vehicle at a first moment when the first images were obtained. The method may comprise, when synthesizing second images obtained from the cameras at a second moment after the first moment, determining, using locations of the cameras at the second moment, whether a second composite image to which the second images are composited includes a blind area. The method may comprise, based on determining that the second composite image includes the blind area, transmitting, to the display, the second composite image with which a portion of the first composite image corresponding to the blind area is combined.

In an embodiment, there may be provided a non-transitory, computer-readable storage medium including instructions. The instructions may, when executed by a processor of an electronic device of a vehicle, cause the electronic device to obtain first images of cameras through the communication interface. The cameras may be respectively positioned on portions of the vehicle rotatably coupled to each other. The instructions may, when executed by the processor, cause the electronic device to transmit, to the display connected through the communication interface, a first composite image which is composited to provide an aerial view of the vehicle at a first moment when the first images were obtained. The instructions may, when executed by the processor, cause the electronic device to, when synthesizing second images obtained from the cameras at a second moment after the first moment, determine, using locations of the cameras at the second moment, whether a second composite image to which the second images are composited includes a blind area. The instructions may, when executed by the processor, cause the electronic device to, based on determining that the second composite image includes the blind area, transmit, to the display, the second composite image with which a portion of the first composite image corresponding to the blind area is combined.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an example of a vehicle including an electronic device according to an embodiment;

FIGS. 1B and 1C illustrate an exemplary exterior of a conventional truck with an electronic device according to an embodiment;

FIG. 2 is a block diagram illustrating an electronic device according to an embodiment;

FIGS. 3A and 3B illustrate exemplary locations of cameras included in a vehicle including a tractor and a trailer;

FIG. 4 is a flowchart for an electronic device according to an embodiment;

FIGS. 5A and 5B illustrate an example of a composite image displayed by an electronic device included in a vehicle driving forward; and

FIGS. 6A and 6B illustrate an example of a composite image displayed by an electronic device included in a vehicle driving backward.

### DETAILED DESCRIPTION

Specific structural or functional descriptions of embodiments according to the concept of the disclosure disclosed herein are merely exemplified for the purpose of describing embodiments according to the concept of the disclosure, and embodiments according to the concept of the disclosure may be implemented in various forms and are not limited to the embodiments described in the disclosure.

Since various changes or modifications may be made to embodiments according to the concept of the disclosure, specific embodiments are be illustrated in the drawings and described herein. However, without limitations to the embodiments according to the concept of the disclosure, all changes and/or equivalents or replacements thereto also belong to the scope of the disclosure.

The terms “first” and “second” may be used to describe various components, but the components should not be limited by the terms. The terms are solely for the purpose of distinguishing one component from another. For example, a first component may be referred to as a second component, without departing from the scope of the claims according to the concept of the disclosure. Similarly, a second component may also be referred to as a first component.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween. Other terms or phrases representing the relationship between components, such as ‘between,’ ‘immediately between,’ or ‘directly adjacent to,’ may be interpreted the same way.

The terms as used herein are provided merely to describe some embodiments thereof, but not to limit the disclosure. As used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments are described in detail with reference to the accompanying drawings. However, the disclosure is not limited to the exemplary embodiments. The same reference denotations are used to refer to the same members throughout the drawings.

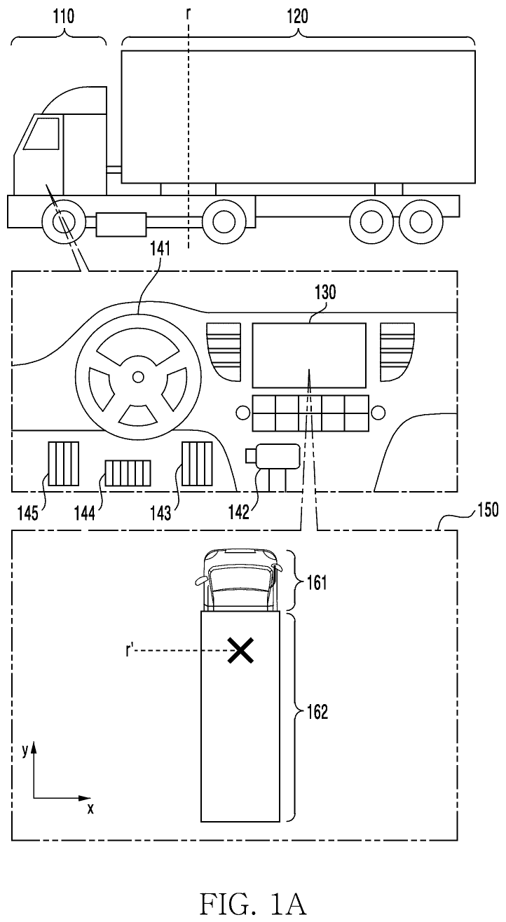

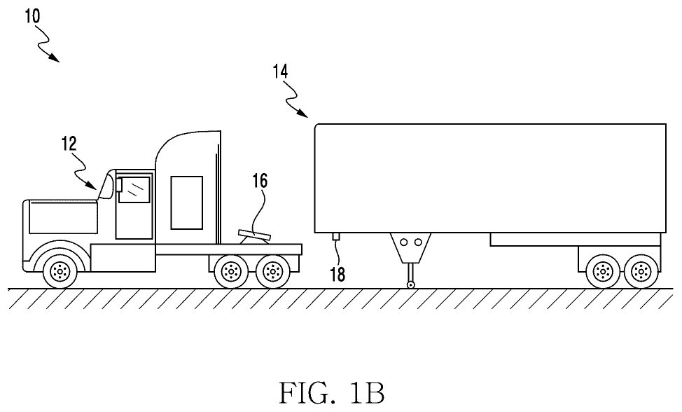

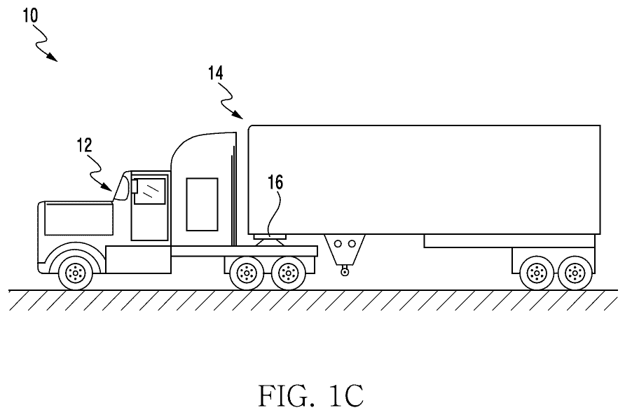

FIG. 1 illustrates an example of a vehicle including an electronic device 101 according to an embodiment. Referring to FIG. 1, a vehicle including a tractor 110 and a trailer 120 is exemplarily illustrated. The vehicle including the tractor 110 and the trailer 120 rotatably coupled to each other may be referred to as a truck. The vehicle and/or truck may include only the tractor 110 as well as both the tractor 110 and the trailer 120. The trailer 120 connected to the tractor 110 may be rotatably coupled to the tractor 110 to support driving on a curved road. The trailer 120 may have a structure for accommodating people and/or freight. The trailer 120 may include electronic components that may be controlled by the tractor 110, such as sensors and/or taillights.

Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

Referring to FIG. 1, a tractor 110 and a trailer 120 of a vehicle coupled around a rotational axis r are illustrated. The tractor 110 may be configured to tow or haul the trailer 120, which may accommodate or cater or carry people and/or freight. The tractor 110 may include an internal combustion engine referred to as an engine, a motor, or any combination thereof. The tractor 110 may include a battery and/or a fuel tank (e.g., a fuel tank designed to store gasoline, diesel, liquid natural gas (LNG), liquefied petroleum gas (LPG) and/or hydrogen). For example, the tractor 110 including a rechargeable battery and a motor driven by electrical energy stored in the battery may be referred to as an electric vehicle (EV) and/or an electric truck. For example, the tractor 110 including not only a battery and a motor but also a fuel tank and an engine may be referred to as a hybrid vehicle (e.g., plug-in hybrid electric vehicle (PHEV)).

Referring to FIG. 1, an exemplary interior of the tractor 110 is illustrated. For example, the tractor 110 may include a steering wheel 141 disposed in the cockpit. The tractor 110 may include one or more pedals (e.g., an accelerator pedal 143, a brake pedal 144, and/or a clutch pedal 145) disposed in the cockpit. The tractor 110 may include a transmission for adjusting the relationship between the driving direction, driving force, and/or driving speed of the tractor 110. The tractor 110 may include a shift lever 142 for adjusting the mode of the transmission (e.g., parking, neutral, forward driving, backward driving, and/or manual driving). The tractor 110 may include a display 130. Meanwhile, although FIG. 1 illustrates that the shift lever 142 is present in a physical form, the shift lever 142 may be displayed on the display 130 to control the mode of the transmission by the user's touch gesture. Alternatively, the shift lever 142 may be configured in a physical button type in the cabin of the tractor 110 (e.g., the position of the headliner between the front windshield of the vehicle and the ceiling). The display 130 may be disposed on the dashboard of the tractor 110. On the dashboard of the tractor 110, one or more buttons and/or one or more dials may be disposed to control different functions of the tractor 110 (e.g., air conditioning, radio, and/or emergency lights, web search, streaming service, Internet service, communication function, etc.).

The vehicle may include a plurality of electronic components. An electronic component included in the vehicle may be referred to as an electronic control unit (ECU). The electronic components may include sensing means for obtaining and/or detecting information related to the vehicle and/or the external environment of the vehicle, and/or driving means for controlling the vehicle. The driving means may include a steering motor for changing the driving direction of the vehicle according to the steering angle of the handle 141, an electronic transmission controlled by the shift lever 142, an electronic brake (or electronic parking brake) for outputting braking power according to the movement of a pedal (e.g., the brake pedal 144), an anti-lock brake system (ABS) for controlling the output of the braking power, and/or an electronic throttle control (ETC) valve for controlling the output of the engine according to the movement of a pedal (e.g., the accelerator pedal 143).

The sensing means may include a seat sensor included in the seat for detecting a person sitting on the seat, one or more temperature sensors for detecting the temperature of interior air and/or exterior air of the vehicle, a global positioning system (GPS) sensor for detecting the geographic location of the vehicle, and an inertial measurement unit (IMU) for detecting the physical movement (e.g., translation movement and/or rotational movement) of the vehicle (e.g., an accelerometer, a gyroscope sensor, a geomagnetic sensor or a combination thereof). The embodiments are not limited thereto, and the sensing means may include a camera, a depth camera, a time of flight (ToF) sensor, a light detection and ranging (LiDAR), a radar, a proximity sensor, and/or an ultra-wideband (UWB) sensor as a means for detecting an external object.

In an embodiment, the advanced driver assistance system (ADAS) of the vehicle may be electrically connected to the sensing means and the driving means described above. The ADAS may include a circuit configured to execute one or more functions to assist the driver of the vehicle. The ADAS may provide information to the driver sitting in the tractor 110 on the display 130. According to an embodiment, the electronic device may visualize vehicle-related information on the display 130 as at least a portion of the ADAS.

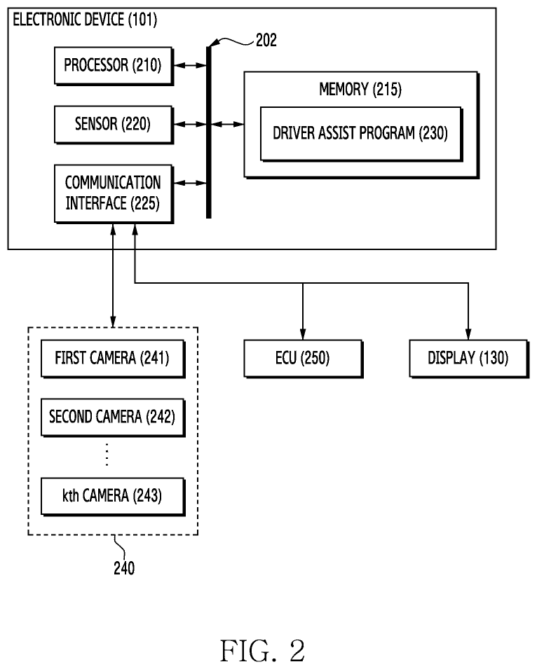

Referring to FIG. 1, an exemplary screen 150 displayed on the display 130 controlled by the electronic device according to an embodiment is illustrated. In the screen 150, the electronic device may be configured to provide an aerial view of the tractor 110 and the trailer 120. The aerial view may be referred to as an around view. A combination of the electronic device and the display 130 for providing an aerial view may be referred to as an around view monitor (AVM). A hardware configuration of the electronic device configured to provide an aerial view is exemplarily described with reference to FIG. 2.

Referring to the exemplary screen 150 of FIG. 1, the electronic device may display a visual object 161 corresponding to the tractor 110 and a visual object 162 corresponding to the trailer 120 on the display 130. Each of the visual objects 161 and 162 may include an image representing the exterior of the tractor 110 and the trailer 120 viewed from above and/or a three-dimensional graphical object. In the screen 150, the visual objects 161 and 162 corresponding to the tractor 110 and the trailer 120, respectively, may be disposed in a vertical direction (e.g., the direction of the y-axis) of the screen 150. For example, the visual object 161 corresponding to the tractor 110 may be disposed above the visual object 162 corresponding to the trailer 120 in the screen 150. The direction (e.g., the direction of the +y-axis) of the visual object 161 in the screen 150 may indicate the driving direction of the tractor 110. The direction of the visual object 161 may face an upper edge of the display 130.

The location relationship between the tractor 110 and the trailer 120 connected by the rotational axis r may be changed while the vehicle including the tractor 110 and the trailer 120 is driving. For example, when the driving direction of the vehicle is changed by the rotation of the steering wheel 141 (e.g., rotation by the driver of the vehicle and/or by the ADAS), the direction of the tractor 110 faces the changed driving direction and, then, the direction of the trailer 120 may face the changed driving direction. According to an embodiment, the electronic device may change the location relationship between the visual objects 161 and 162 according to the location relationship between the tractor 110 and the trailer 120 in the screen 150 displayed on the display 130. For example, the electronic device may display the visual objects 161 and 162 so that the angle between the visual objects 161 and 162 on the rotational axis r′ in the screen 150 corresponds to the angle between the tractor 110 and the trailer 120 on the rotational axis r.

According to an embodiment, the electronic device may display at least one image obtained from cameras disposed on the tractor 110 and the trailer 120 in the screen 150 including the visual objects 161 and 162. In order to visualize the vehicle viewed from the sky and the surrounding environment of the vehicle, the electronic device may distort the at least one image and display the distorted image on the screen 150. For example, from images of cameras mounted on the surface and/or frame of the vehicle in different directions from the vertical direction, the electronic device may generate or display a composite image (or composite image) as the vehicle is viewed at a location spaced apart from the vehicle (e.g., a location above the vehicle) along the vertical direction. Synthesis of images may include an operation of seamlessly combining the boundaries of the images, like stitching.

In an embodiment, each of the cameras may continuously output images in a time domain. The electronic device may continuously synthesize images obtained from the cameras in the time domain and continuously display the composite images representing the aerial view of the vehicle on the display 130. The composite images continuously displayed on the display 130 may be a real-time video of the surrounding environment of the vehicle. The embodiments are not limited thereto, and the electronic device may transmit or stream the video including the composite images to a user terminal (e.g., a smartphone, a tablet personal computer (PC), a head-mounted display (HMD), a desktop, and/or a laptop) that is distinct from the vehicle through a network (e.g., the Internet).

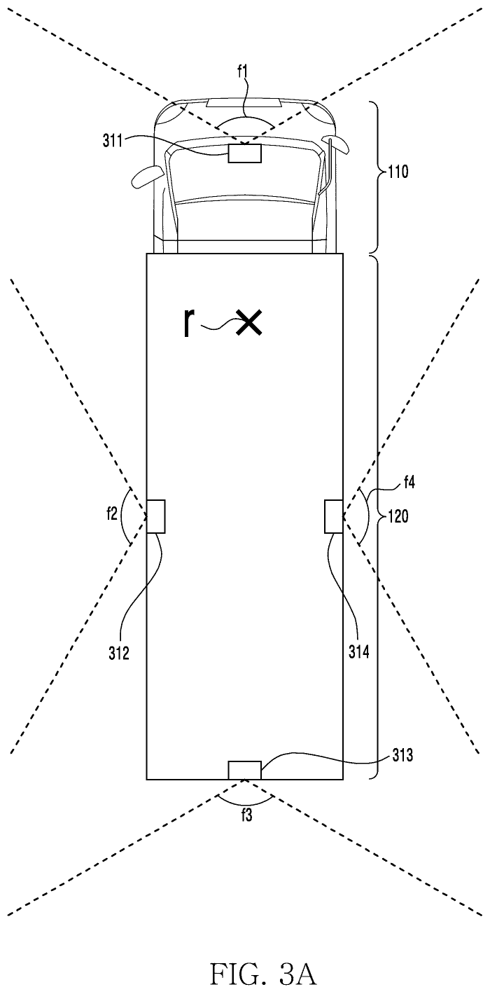

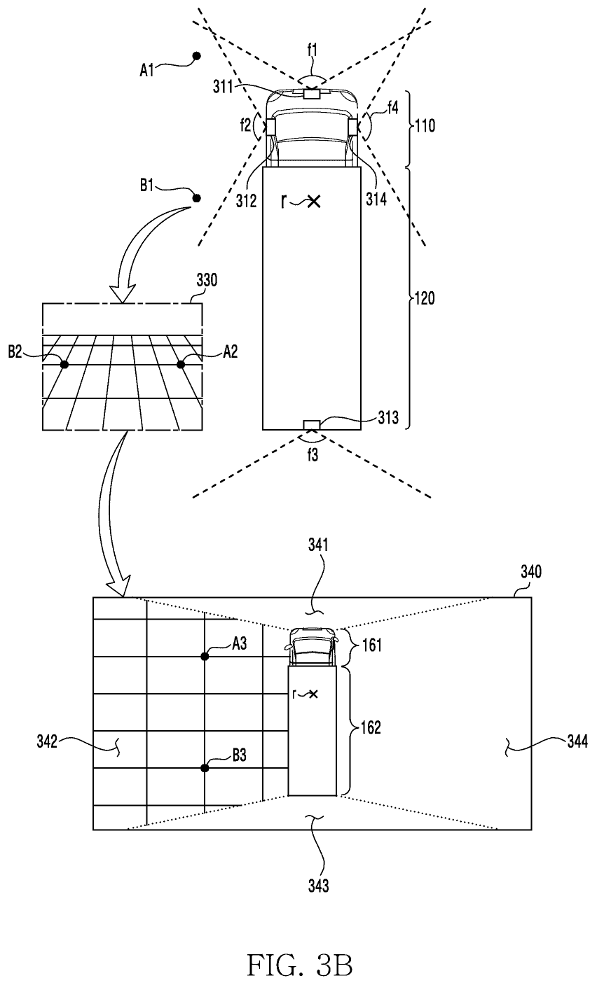

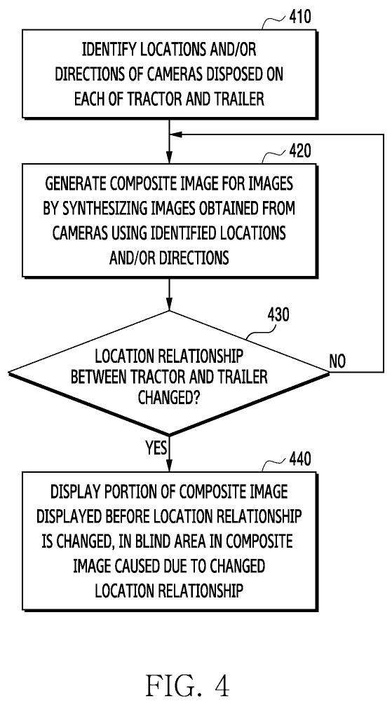

The electronic device that has obtained the images of the cameras disposed on the tractor 110 and the trailer 120 may combine the images using the location relationship between the tractor 110 and the trailer 120 that change irregularly while the vehicle is driving. For example, if the trailer 120 is excessively rotated relative to the tractor 110, the fields-of-view of the cameras may be separated. The electronic device may detect or identify an area outside the FoVs in the external environment surrounding the vehicle, using the FoVs of the cameras disposed on the tractor 110 and the trailer 120. Another area different from the area included in the FoVs in the external environment may be referred to as a blind area. The locations of the cameras in the vehicle, used to generate a composite image representing an aerial view of the vehicle are exemplarily described with reference to FIGS. 3A and/or 3B. An operation of an electronic device combining images of the cameras using a location relationship between the cameras is described with reference to FIG. 4.

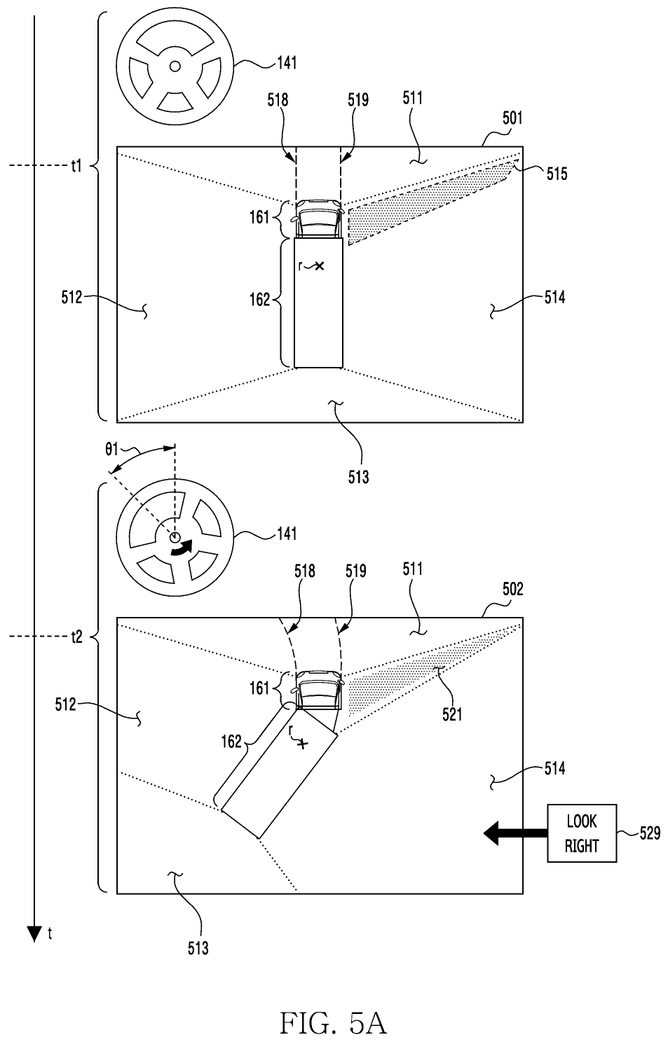

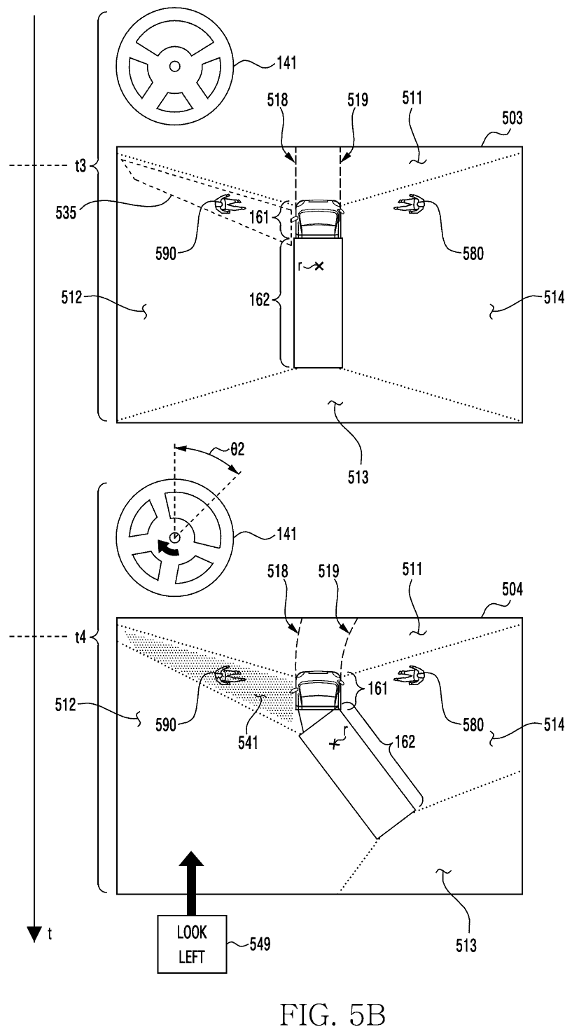

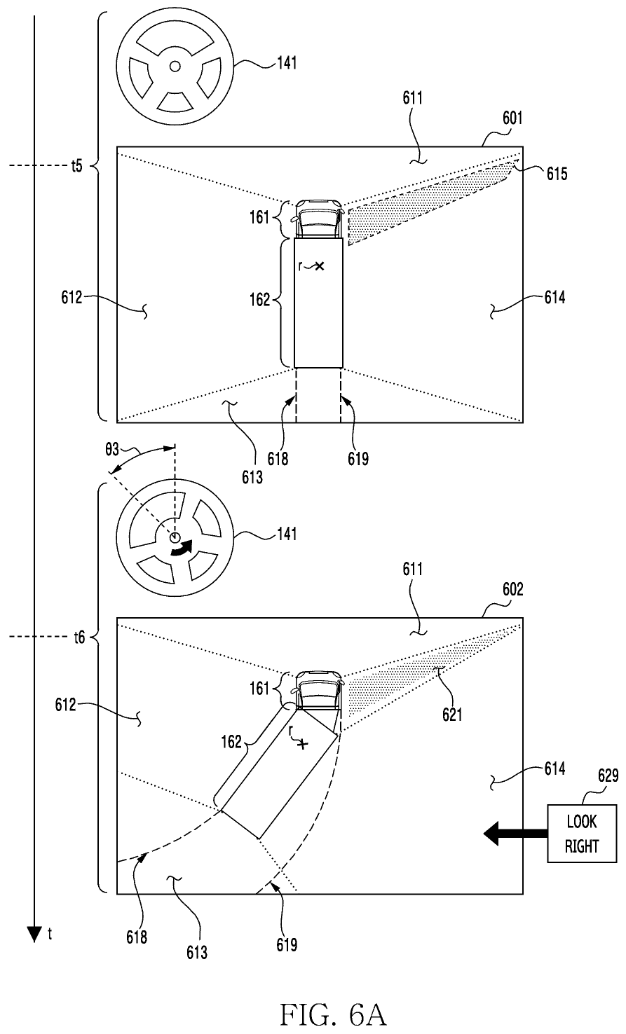

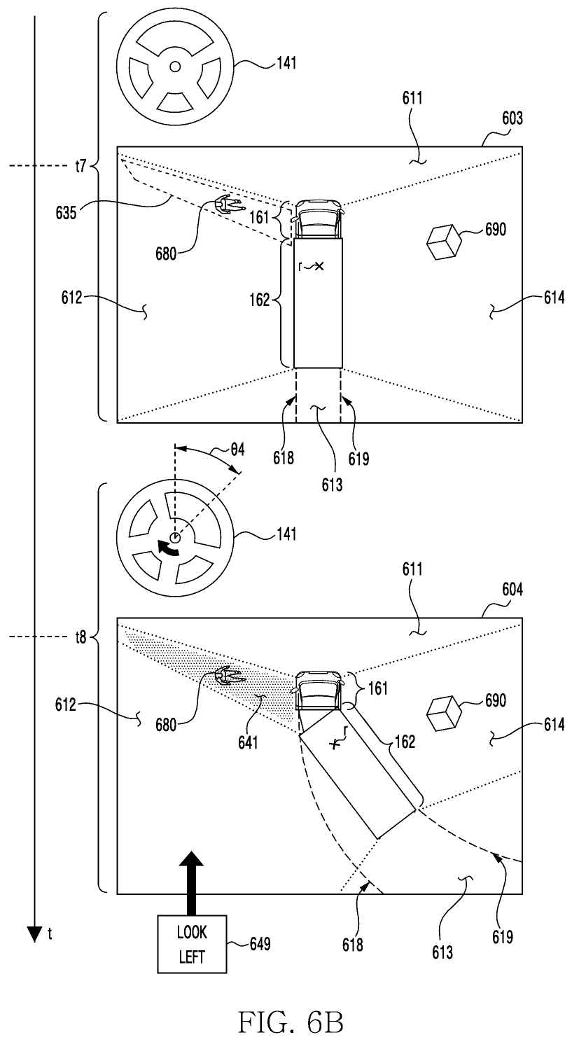

When the blind area is displayed as blank on the display 130, the driver may be required to directly look outside the vehicle in order to identify an external object in the blind area. According to an embodiment, the electronic device may display a second portion of a second composite image generated (or displayed) before a first composite image on a first portion of the first composite image corresponding to the blind area. By displaying the second portion-combined first composite image on the display 130, the electronic device may provide information related to the blind area to the driver. An exemplary operation of an electronic device combining at least a portion of the second composite image is described with reference to FIGS. 5A, 5B, 6A, and/or 6B.

As described above, the electronic device according to an embodiment may supplement a blind area generated by the refractive characteristics of the truck. For example, the electronic device may replace, or may synthesize, a portion corresponding to the blind area in the currently displayed composite image with a portion of the composite image displayed in the past. By supplementing the blind area, the electronic device may provide intuitive information related to the surrounding environment of the vehicle to the driver of the vehicle.

FIGS. 1B and 1C illustrate an exemplary exterior of a conventional truck with an electronic device according to an embodiment. FIG. 1B illustrates a state in which the tractor 12 and the trailer 14 are not connected.

FIG. 1C illustrates a state in which the tractor 12 and the trailer 14 are connected. In an embodiment of the disclosure, the trailer 14 is selectively connected by a fifth wheel hitch 16 carried by the tractor 12, which engages the kingpin 18 fixed to the trailer 14 in a known manner.

The trailer 14 shown in FIGS. 1B and 1C of the disclosure is illustrated as a “semi-trailer”, but this is for convenience of description, and it should not be understood that the embodiments of the disclosure are applied only to a “semi-trailer” form.

FIG. 2 is a block diagram illustrating an electronic device 101 according to an embodiment. The electronic device 101 according to an embodiment may be included in a vehicle (e.g., a truck) having refractive characteristics described with reference to FIG. 1. The electronic device 101 may be included in the vehicle as at least a portion of an ECU, ADAS, and/or autonomous driving system.

Referring to FIG. 2, according to an embodiment, the electronic device 101 may include at least one of a processor 210, memory 215, a sensor 220, and a communication interface 225. The processor 210, the memory 215, the sensor 220, and the communication interface 225 may be electrically and/or operatively connected to each other by a circuit such as a communication bus 202. Hereinafter, “circuits are operatively coupled” may mean that a direct or indirect connection between the circuits is established wiredly or wirelessly so that a second circuit is controlled by a first circuit among the circuits. Although illustrated based on different blocks, the embodiments are not limited thereto, and some (e.g., at least a portion of the memory 215 and the processor 210) of the circuits of FIG. 2 may be included in a single integrated circuit like a system on chip (SoC). The type and/or number of the circuits included in the electronic device 101 is not limited as illustrated in FIG. 2. For example, the electronic device 101 may include only some of the circuits illustrated in FIG. 2.

According to an embodiment, the processor 210 of the electronic device 101 may include a circuit for processing data based on a plurality of instructions. For example, the circuit for processing data may include an arithmetic and logic unit (ALU), a floating point unit (FPU), a field programmable gate array (FPGA), a central processing unit (CPU), and/or an application processor (AP). The number of processors 210 may be one or more. The processor 210 may have a structure of a multi-core processor such as a dual core, a quad core, a hexa core, or an octa core. In the processor 210 having a structure of a multi-core processor, the functions described with reference to the disclosure may be collectively performed by different cores.

According to an embodiment, the memory 215 of the electronic device 101 may include a hardware component for storing data and/or instructions input and/or output to/from the processor 210. The memory 215 may include, e.g., volatile memory such as random-access memory (RAM), and/or non-volatile memory such as read-only memory (ROM). The volatile memory may include, e.g., at least one of dynamic RAM (DRAM), static RAM (SRAM), cache RAM, and pseudo SRAM (PSRAM). The non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC).

According to an embodiment, the sensor 220 of the electronic device 101 may generate electrical information that may be processed by the processor 210 and/or the memory 215 from non-electronic information related to the vehicle including the electronic device 101 and/or the electronic device 101. For example, the sensor 220 may include a global positioning system (GPS) sensor for detecting the geographic location of the electronic device 101. In addition to the GPS method, the sensor 220 may generate information indicating the geographic location of the electronic device 101 based on a global navigation satellite system (GNSS) such as Galileo and BeiDou (compass). The information may be stored in the memory 215, processed by the processor 210, and/or transmitted to another electronic device distinct from the electronic device 101 through the communication interface 225. The sensor 220 is not limited to the foregoing, and may include an image sensor for detecting an electromagnetic wave including light, an illumination sensor, an inertial measurement unit (IMU) (e.g., an acceleration sensor, a gyro sensor and/or a geomagnetic sensor), and/or a time-of-flight (ToF) sensor.

According to an embodiment, the communication interface 225 of the electronic device 101 may include a circuit, a port, and/or a connector for supporting communication with an external electronic device distinct from the electronic device 101. For example, the communication interface 225 may include a port and/or a connector for supporting wired communication, such as a controller area network (CAN), a universal serial bus (USB), and/or a communication (COM) port. For example, the communication interface 225 may include a port and/or a connector based on an onboard diagnostic (OBD) standard. The embodiments are not limited thereto, and the communication interface 225 may include a circuit and/or an antenna for supporting wireless communication, such as Wi-Fi, Bluetooth, Bluetooth low energy (BLE), and/or near field communication (NFC). The communication interface 225 may include a modem for generating an electrical signal according to a communication protocol.

Referring to FIG. 2, the electronic device 101 may be electrically and/or operatively connected to electronic components included in the vehicle through the communication interface 225. For example, the electronic device 101 may communicate with the cameras 240 of the vehicle through the communication interface 225. The cameras 240 may be disposed at different portions of the vehicle and may have FoVs that are at least partially overlap or do not overlap each other. The FoVs, locations, and/or directions of the cameras 240 may be different from each other. For example, from at least one of k cameras (e.g., a first camera 241, a second camera 242, . . . , a kth camera 243), the electronic device 101 may obtain or receive an image and/or video. The electronic device 101 may store information about the FoVs, the locations, and/or the directions, or may obtain the same from at least one of the cameras 240. Although an embodiment in which the electronic device 101 is directly connected to the cameras 240 is described, the embodiments are not limited thereto, and the cameras 240 may be indirectly connected to the electronic device 101 through the ECU 250.

For example, the electronic device 101 may be electrically connected to the ECU 250 of the vehicle through the communication interface 225. From the ECU 250, the electronic device 101 may receive or obtain information about a vehicle including an ECU 250. For example, the electronic device 101 may receive, from the ECU 250, information including at least one of the vehicle's driving direction (e.g., forward and/or backward), the angle of the steering wheel (e.g., the steering wheel 141 of FIG. 1), or the mode of the transmission (e.g., the mode indicated by the shift lever 142 of FIG. 1). The embodiments are not limited thereto, and the electronic device 101 may obtain or receive information indicating the location relationship (e.g., the angle between the portions) between different portions (e.g., the tractor 110 and/or trailer 120 of FIG. 1) of the vehicle through the ECU 250.

In the memory 215 of the electronic device 101 according to an embodiment, one or more instructions (or commands) indicating a computation and/or operation to be performed on data by the processor 210 may be stored. A set of one or more instructions may be referred to as firmware, operating system, process, routine, sub-routine, program, and/or software application (hereinafter, application). For example, the electronic device 101 and/or the processor 210 may perform at least one of the operations of FIG. 4 when a set of instruction distributed in the form of an operating system, firmware, driver, and/or application is executed. Hereinafter, an “application is installed on the electronic device 101” may mean that one or more instructions provided in the form of an application are stored in the memory 215 of the electronic device 101, and the one or more applications are stored in a format executable by the processor 210 of the electronic device 101 (e.g., a file having an extension designated by the operating system of the electronic device 101).

Referring to FIG. 2, a driver assist program 230 may be installed in the memory 215 of the electronic device 101. By executing the instructions included in the driver assist program 230, the processor 210 of the electronic device 101 may combine or synthesize images obtained from the cameras 240. The processor 210 executing the driver assist program 230 may detect or identify the locations and/or directions of the cameras 240 using the state of the vehicle indicated by the information received from the ECU 250. Using the locations and/or the directions, the processor 210 may perform stitching on the images of the cameras 240.

The embodiments are not limited thereto, and the electronic device 101 may compare the images obtained from the cameras 240 to detect or determine the location relationship between the cameras 240 obtaining the images and/or the location relationship between the portions where the cameras 240 are disposed (e.g., the location of the rotational axis r of FIG. 1 and/or the angle between the portions on the rotational axis r). Using the location relationship, the electronic device 101 may distort or/or rotate the images of the cameras 240. By combining the distorted and/or rotated images, the electronic device 101 may obtain or generate a composite image of the images (e.g., an image representing the aerial view of the vehicle). The composite image may be transmitted to the display 130 through the communication interface 225. When images are continuously received from the cameras 240 in the time domain, the processor 210 may continuously perform synthesis on the images to continuously generate or output composite images to be displayed through the display 130. By continuously displaying the composite images through the display 130, the processor 210 may provide a video including the aerial view of the vehicle.

Hereinafter, locations of the cameras 240 of FIG. 2 are exemplarily described with reference to FIG. 3A and/or FIG. 3B.

FIGS. 3A and 3B illustrate exemplary locations of cameras 311, 312, 313, and 314 included in a vehicle including a tractor 110 and a trailer 120. The vehicle of FIGS. 3A and/or 3B may correspond to an example of the vehicle described with reference to FIGS. 1 and/or 2. The cameras 311, 312, 313, and 314 of FIG. 3A and/or 3B may correspond to the cameras 240 of FIG. 2.

Referring to FIG. 3A, exemplary locations of the cameras 311, 312, 313, and 314 of the vehicle are illustrated. The camera 311 may be disposed in a forward direction of the vehicle. The camera 312 may be disposed in the left direction of the vehicle. The camera 313 may be disposed in the backward direction of the vehicle. The camera 314 may be disposed in the right direction of the vehicle. According to an embodiment, the electronic device of the vehicle may obtain information indicating the respective locations, directions, and/or FoVs of the cameras 311, 312, 313, and 314. Using the above information, the electronic device may identify the FoVs (e.g., f1, f2, f3, and f4) of the cameras 311, 312, 313, and 314.

Referring to FIG. 3A, the cameras 312, 313, and 314 except for the camera 311 facing in the forward direction may be disposed on the trailer 120. The camera 311 may be disposed on the frame, front glass, and/or rear mirror of the vehicle. The embodiments are not limited thereto. The cameras 312, 313, and 314 may be disposed at different locations of the trailer 120 and may be connected to an electronic device (e.g., the electronic device 101 of FIG. 2) through a communication interface (e.g., the communication interface 225 of FIG. 2).

Referring to FIG. 3B, other locations of the cameras 311, 312, 313, and 314 of the vehicle are exemplarily illustrated. The cameras 311, 312, and 314 disposed on the tractor 110 may be disposed in the forward direction, the left direction, and the right direction, respectively. The camera 313 disposed on the trailer 120 may be disposed in the backward direction of the vehicle. For example, the cameras 312 and 314 may be disposed on the B pillar, side mirror and/or door of the vehicle. For example, the camera 313 may be disposed on the rear surface of the trailer 120 or on the rear bumper of the trailer 120.

Referring to FIG. 3A and/or 3B, at least one of the cameras 311, 312, 313, and 314 connected to the electronic device may be disposed on the trailer 120. Through an electrical connection between the tractor 110 and the trailer 120, the electronic device may obtain information from at least one camera (e.g., the cameras 312, 313, and 314 in an embodiment of FIG. 3A, or the camera 313 in an embodiment of FIG. 3B) disposed on the trailer 120. When an electrical connection between the tractor 110 and the trailer 120 is established, the electronic device may communicate with at least one camera disposed on the trailer 120 based on plug-and-play (PnP), and obtain information indicating the location of the at least one camera from the at least one camera.

Referring to FIG. 3A and/or 3B, the electronic device may distort images of the cameras 311, 312, 313, and 314 because the cameras 311, 312, 313, and 314 face in a direction (e.g., a direction facing outward of the vehicle) other than the vertical direction of the vehicle. Referring to FIG. 3B, an image 330 obtained from a camera 312 disposed in the left direction of the vehicle is exemplarily illustrated. From the camera 312 disposed obliquely from the left surface of the vehicle toward the left ground of the vehicle, the electronic device may obtain an image 330 related to the left environment of the vehicle. Referring to the exemplary image 330 of FIG. 3B, a grid in the image 330 may represent the ground included in the image 330. Points A2 and B2 in the image 330 may correspond to points A1 and B1, respectively, on the ground. The exemplary image 330 of FIG. 3B may include the surrounding environment close to the vehicle, the horizontal line of the ground, and the sky.

By distorting the images of the cameras 311, 312, 313, and 314, including the image 330, the electronic device may obtain a composite image 340 to be displayed on the display. Referring to the exemplary composite image 340 of FIG. 3B, the images of the cameras 311, 312, 313, and 314 may be disposed in the composite image 340 with respect to the visual objects 161 and 162 corresponding to the tractor 110 and the trailer 120, respectively. For example, the image 330 of the camera 312 disposed in the left direction of the vehicle may be disposed on the portion 342 located on the left side of the visual objects 161 and 162 representing the vehicle in the composite image 340. The grid illustrated in the portion 342 may correspond to a ground surface expressed as the grid in the image 330. For example, points A3 and B3 in the composite image 340 may correspond to points A2 and B2, respectively, in the image 330. Similarly, the electronic device may distort the image obtained from the camera 311 and may dispose the distorted image on the portion 341 of the composite image 340. The electronic device may dispose the image of the camera 314 on the portion 344 of the composite image 340. The electronic device may dispose the image of the camera 316 on the portion 343 of the composite image 340.

FIG. 4 is a flowchart for an electronic device according to an embodiment. The electronic device 101 and/or the processor 210 of FIG. 2 may perform the operations of the electronic device described with reference to FIG. 4. For example, the processor may execute instructions stored in the memory (e.g., memory 215 of FIG. 2) (e.g., instructions included in the driver assist program 230 of FIG. 2) to cause the electronic device to perform at least one of the operations of FIG. 4.

Referring to FIG. 4, in operation 410, the processor of the electronic device according to an embodiment may identify locations and/or directions of cameras disposed on each tractor and trailer. The tractor and the trailer of operation 410 may respectively correspond to the tractor 110 and the trailer 120 of FIG. 1. The cameras of operation 410 may include the cameras 240 of FIG. 2. The processor may detect or identify the respective locations, directions, and/or FoVs of the cameras using information identified from the cameras (e.g., identifiers of the cameras, such as IDs). The cameras may be disposed on each of the rotatably coupled portions (e.g., the tractor and/or the trailer) of the vehicle.

Referring to FIG. 4, in operation 420, the processor of the electronic device according to an embodiment may synthesize images obtained from the cameras of operation 410 using the locations and/or directions identified by operation 410 to generate a composite image of the images. The composite image of operation 420 may include the composite image 340 of FIG. 3B. For example, the processor may obtain or generate a composite image by performing the operations described above with reference to FIG. 3A and/or 3B. The composite image of operation 420 may be generated to provide an aerial view of the vehicle.

The composite image generated using operation 420 may be displayed on a display included in the electronic device or connected to the electronic device. For example, the processor may transmit the composite image of operation 420 to the display connected through the communication interface.

Referring to FIG. 4, in operation 430, the processor of the electronic device according to an embodiment may determine whether the location relationship between the tractor and the trailer has been changed. From the ECU (e.g., the ECU 250 of FIG. 2) included in the vehicle, the processor may obtain information related to the location relationship between the tractor and the trailer. The information may include the driving direction and/or driving speed of the vehicle calculated by the sensor (e.g., a sensor of the rotational axis between the tractor and the trailer) for detecting the location relationship between the tractor and trailer and the ECU. If the location relationship between the tractor and the trailer has not been changed, or before the location relationship is changed (No in 430), the processor may perform operation 420 to maintain the generation and/or display of the composite image. When the location relationship between the tractor and the trailer is changed (Yes in 430), the processor may perform operation 440.

Referring to FIG. 4, in operation 440, the processor of the electronic device according to an embodiment may display a portion of the composite image displayed before the location relationship was changed in the blind area within the composite image, caused by the changed location relationship. As the location relationship changes, a blind area may occur, disappear, or change within the composite image. The processor detecting a change in the location relationship may detect the blind area generated by the changed location relationship. The processor may display, in the detected blind area, a portion of the composite image displayed before the location relationship is changed.

In an embodiment, the processor may visually highlight the blind area generated due to a change in the location relationship between the tractor and the trailer. For example, the processor may display a figure (e.g., a polygon) representing the blind area. The processor may display a notification message indicating the occurrence of the blind area or may output sound.

Hereinafter, an exemplary case in which the electronic device performing the operations of FIG. 4 displays a composite image and supplements a blind area is described with reference to FIG. 5A, 5B, 6A and/or 6B.

FIGS. 5A and 5B illustrate an example of a composite image displayed by an electronic device included in a vehicle driving forward. The operations of the electronic device described with reference to FIG. 5A and/or 5B may be performed by the electronic device 101 and/or the processor 210 of FIG. 2. The operations of the electronic device described with reference to FIG. 5A and/or 5B may be related to the operations of the electronic device described with reference to FIG. 4. The vehicle of FIG. 5A and/or 5B may include the tractor 110 and/or the trailer 120 of FIG. 1.

Referring to FIG. 5A, a steering wheel 141 of a vehicle while driving in the forward direction and composite images 501 and 502 synthesized by the electronic device are exemplarily illustrated. At moment t1, the steering wheel 141 may not be inclined in any direction, and the vehicle may go straight. At moment t1, the steering angle of the steering wheel 141 may be 0°. The electronic device detecting the steering angle may display visual objects 518 and 519 representing the expected path of the vehicle on the composite image 501 obtained from the vehicle cameras. The visual objects 518 and 519 having the shape of a dashed line are exemplarily illustrated, but embodiments are not limited thereto. At moment t1 when the steering angle of the steering wheel 141 is 0°, the electronic device may display visual objects 518 and 519 having a shape in solid line and extending from the visual object 161 corresponding to the tractor of the vehicle.

Referring to FIG. 5A, the electronic device may display a composite image 501 of images of cameras facing in different directions. In order to provide an aerial view of the vehicle, the electronic device may display visual objects 161 and 162 respectively representing the tractor and trailer of the vehicle in the center of the composite image 501. In the composite image 501, the electronic device may combine an image of the camera disposed in the forward direction of the vehicle with the portion 511 corresponding to the forward direction of the vehicle. In the composite image 501, the electronic device may combine an image of the camera disposed in the left direction of the vehicle with the portion 512 corresponding to the left direction of the vehicle. In the composite image 501, the electronic device may combine an image of the camera disposed in the backward direction of the vehicle with the portion 513 corresponding to the backward direction of the vehicle. In the composite image 501, the electronic device may combine an image of the camera disposed in the right direction of the vehicle with the portion 514 corresponding to the right direction of the vehicle.

Referring to FIG. 5A, at moment t2 after moment t1, the steering wheel 141 may rotate counterclockwise along the angle Θ1. The steering angle of the steering wheel 141 at moment t2 may be parameterized into a numerical value (e.g., −Θ1) having a sign indicating the counterclockwise direction (e.g., a negative sign). The electronic device detecting the steering angle may display the visual objects 518 and 519 indicating an expected path according to the detected steering angle on the composite image 502. For example, on the exemplary composite image 502 displayed by the electronic device at moment t2, the electronic device may display visual objects 518 and 519 shaped as a curve curved to the left to indicate that the vehicle is to drive in the forward left direction.

At moment t2 when the vehicle drives in the forward left direction, the angle between the tractor and the trailer may be refracted along the driving direction of the vehicle. The electronic device detecting the refraction of the vehicle may rotate the visual object 162 corresponding to the trailer with respect to the visual object 161 corresponding to the tractor on the composite image 502. For example, the electronic device may maintain the location of the visual object 161 in the composite image 502 and rotate the visual object 162 with respect to the rotational axis r. Because the cameras disposed on the vehicle have finite FoVs, the refraction of the vehicle may cause separation between the FoVs.

Referring to FIG. 5A, at moment t2, since the tractor travels in the forward left direction, a blind area may occur in the right direction of the vehicle. The electronic device detecting the blind area may display the visual object 529 guiding the blind area together with the composite image 502. For example, the electronic device may transmit information and/or signals for displaying the composite image 502 and the visual object 529 superimposed on the composite image 502 to the display. Referring to the exemplary visual object 520 of FIG. 5A, the electronic device may display text (e.g., “look right”) indicating the location of the blind area. The embodiments are not limited thereto, and the electronic device may output an icon (e.g., an arrow), an image, a video, and/or a sound indicating the blind area.

Referring to FIG. 5A, at moment t2 when the blind area is detected, the electronic device may detect a portion 521 corresponding to the blind area in the composite image 502. In the portion 521, the electronic device may display the portion 515 of the composite image 501 displayed at moment t1 before moment t2. The portions 515 and 521 may have locations, sizes and/or shapes consistent with each other in the composite images 501 and 502, respectively. The electronic device may combine or display the portion 515 of the composite image 501 with/on the portion 521 of the composite image 502 displayed at moment t2. At moment t2, although it is impossible to obtain an image for the blind area from the camera, the electronic device may visualize the external space in the portion 521 corresponding to the blind area.

Referring to FIG. 5B, composite images 503 and 504 displayed by an electronic device of a vehicle driving in the forward direction are exemplarily illustrated. At moment t3 when the steering angle of the steering wheel 141 is 0°, the electronic device may display visual objects 518 and 519 having the shape of a straight line extending in the vertical direction from the visual object 161 corresponding to the tractor. At moment t3 when the vehicle goes straight, the blind area may be minimized. When an external object (e.g., people) is present around the vehicle, the composite image 503 generated by the electronic device may include a visual object corresponding to the external object. Referring to the exemplary composite image 503 of FIG. 5B, the composite image 503 may include visual objects 580 and 590 respectively corresponding to the people around the vehicle.

At moment t4 after moment t3, the steering wheel 141 may rotate clockwise along the angle Θ2. The steering angle of the steering wheel 141 at moment t4 may be converted into a numerical value (e.g., +Θ2) having a sign indicating the clockwise direction (e.g., a positive sign). The electronic device receiving the numerical value from the ECU may display visual objects 518 and 519 having a shape corresponding to the steering angle. For example, the visual objects 518 and 519 may have a curved shape corresponding to the steering angle of the steering wheel 141 at moment t4. The electronic device may calculate or determine the driving direction of the vehicle (the forward right direction in the exemplary case of FIG. 5B) using the steering angle and/or the speed of the vehicle.

At moment t4 when the vehicle drives in the forward and right direction, the tractor and the trailer may be refracted along the driving direction of the vehicle. The electronic device detecting the refraction of the tractor and trailer may rotate at least one of the visual objects 161 and 162 respectively corresponding to the tractor and trailer on the composite image 504. For example, the electronic device may rotate the visual object 162 corresponding to the trailer around the rotational axis r. The rotational axis r in the composite image 504 may correspond to the rotational axis (e.g., the rotational axis r of FIG. 1) of the tractor and trailer.

Referring to FIG. 5B, the FoVs of the cameras disposed in different directions may be separated by refraction of the tractor and the trailer. While the vehicle drives in the right direction, a blind area may occur in the left direction of the vehicle. At moment t4 when the blind area occurs, the electronic device may not obtain an image for the portion 541 of the composite image 504 corresponding to the blind area. The electronic device detecting the blind area may divide the portion 535 corresponding to the blind area in the composite image 503 displayed at moment t3 before moment t4. The electronic device may combine the divided portion 535 to the portion 541 of the composite image 504. For example, at moment t4, the electronic device may transmit, to the display, the composite image 504 where the portion 535 of the composite image 503 that was generated in the past is combined. The composite image 504 displayed on the display at moment t4 may display the visual object 590 displayed at moment t3. For example, at moment t4, the electronic device may display a visual object 590 corresponding to an external object (e.g., a person) located in the blind area at moment t3 before moment t4.

Referring to FIG. 5B, at moment t4 when the blind area is detected, the electronic device may display a visual object 549 for indicating the blind area on the composite image 504. For example, a visual object 549 including a designated text (e.g., a text for guiding the vehicle in the direction of the blind area) such as “look left” is illustrated, but embodiments are not limited thereto.

As described above, in order to provide an aerial view of the vehicle, the electronic device may repeatedly synthesize or combine images obtained from the cameras at different moments. A first composite image synthesized at a first moment may be used to supplement a blind area generated or detected at a second moment after the first moment. For example, the electronic device may determine whether the second images obtained at the second moment include a blind area using the locations of the cameras at the second moment, at the second moment after the first moment. Based on determining that the second composite image includes a blind area, the electronic device may generate the second composite image where a portion of the first composite image corresponding to the blind area is combined.

FIGS. 6A and 6B illustrate an example of a composite image displayed by an electronic device included in a vehicle driving backward. The operations of the electronic device described with reference to FIG. 6A and/or 6B may be performed by the electronic device 101 and/or the processor 210 of FIG. 2. The operations of the electronic device described with reference to FIG. 6A and/or 6B may be related to the operations of the electronic device described with reference to FIG. 4. The vehicle of FIG. 6A and/or 6B may include the tractor 110 and/or the trailer 120 of FIG. 1.

Referring to FIG. 6A, composite images 601 and 602 generated by an electronic device of a vehicle driving in the backward direction are exemplarily illustrated. At moment t5, the steering angle of the steering wheel 141 may be 0°. The electronic device detecting the steering angle, which is a° of 0, may display visual objects 618 and 619 having a shape according to the steering angle on the composite image 601 of images obtained from the cameras of the vehicle. The visual objects 618 and 619 may extend from the visual object 162 corresponding to the trailer toward the lower end of the composite image 601. At moment t5 when a steering angle of 0° of 0 is detected, the electronic device may display visual objects 618 and 619 having a straight line shape.

Referring to FIG. 6A, the electronic device may display images of the cameras disposed in different directions of the vehicle on the portions 611, 612, 613, and 614 respectively corresponding to the cameras in the composite image 601. For example, an image of the camera disposed in the forward direction of the vehicle may be disposed in the portion 611 corresponding to the forward direction of the vehicle. The electronic device may combine an image of the camera disposed in the left direction of the vehicle with the portion 612 corresponding to the left direction of the vehicle. The electronic device may combine an image of the camera disposed in the backward direction of the vehicle with the portion 613 corresponding to the backward direction of the vehicle. The electronic device may synthesize an image corresponding to the right direction of the vehicle to the portion 614 corresponding to the right direction of the vehicle. The electronic device may display the visual objects 161 and 162 respectively corresponding to the tractor and the trailer of the vehicle in the center of the composite image 601 including the portions 611, 612, 613, and 614.

Referring to FIG. 6A, at moment t6 after moment t5, the steering wheel 141 may rotate counterclockwise along the angle Θ3. As described above with reference to FIG. 5A and/or 5B, the steering angle of the steering wheel 141 at moment t6 may be converted into −Θ3. The electronic device identifying the steering angle of −Θ3 may display the visual objects 618 and 619 having a curved shape along the steering angle of −Θ3 as superimposed on the composite image 602. The visual objects 618 and 619 may extend from the visual objects 161 and 162 respectively corresponding to the tractor and the trailer toward the lower end of the composite image 602.

At moment t6 when the steering wheel 141 is bent, the tractor and the trailer may be refracted as the vehicle drives in the backward direction. The electronic device detecting the refraction of the tractor and trailer may change the location relationship between the visual objects 161 and 162. For example, the electronic device may maintain the location of the visual object 161 corresponding to the tractor in the composite image 602, and may rotate the visual object 162 corresponding to the trailer with respect to the rotational axis r. The refraction of the tractor and trailer may cause separation of the FoVs of the cameras disposed in each of the tractor and trailer.

Referring to FIG. 6A, at moment t6, since the tractor drives in the backward left direction, a blind area may occur on the right side of the vehicle. In response to the blind area, the electronic device may obtain the portion 614 corresponding to the blind area from the composite image 601 displayed before moment t6. The electronic device may combine the obtained portion 614 with the portion 621 corresponding to the blind area in the composite image 602. By displaying the composite image 602 where the portion 621 is combined, the electronic device may supplement the blind area. The electronic device detecting the blind area may display the visual object 629 for indicating the blind area to be superposed on the composite image 602.

Referring to FIG. 6B, composite images 603 and 604 displayed by an electronic device of a vehicle driving in the backward direction are exemplarily illustrated. At moment t7 when the steering angle of the steering wheel 141 is 0° of 0 is detected, the electronic device may display visual objects 618 and 619 having a straight line shape. The visual objects 618 and 619 may have a straight line shape extending from the visual object 162 corresponding to the trailer of the vehicle toward the lower end of the composite image 603 to indicate that the vehicle drives in the backward direction.

Referring to the exemplary composite image 603 of FIG. 6B, since images of the surrounding environment of the vehicle are synthesized, the composite image 603 may include visual objects 680 and 690 representing an external object (e.g., a person and/or an object) included in the surrounding environment. The electronic device may control the display of the vehicle to display the composite image 603.

At moment t8 after moment t7, the electronic device may detect the steering wheel 141 rotated by an angle Θ4 in the clockwise direction. The steering angle of the steering wheel 141 at moment t8 may have a numerical value as +Θ4. The electronic device detecting the numerical value may calculate the driving direction (e.g., backward right direction) of the vehicle using the steering angle and/or the speed of the vehicle indicated by the numerical value. At moment t8, the electronic device may display the visual objects 618 and 619 indicating the driving direction. The visual objects 618 and 619 may have a curved shape extending from the visual object 162 corresponding to the trailer toward the lower end of the composite image 604. At moment t8, the electronic device may display the curved visual objects 161 and 162 according to the location relationship between the tractor and the trailer.

At moment t8 when the vehicle drives in the backward right direction, a blind area may occur in the left direction of the vehicle. At moment t8 when the blind area is detected, the electronic device may identify the portion 641 corresponding to the blind area in the composite image 604. The electronic device detecting the blind area may display a visual object 649 representing the blind area. The electronic device may obtain a portion 635 corresponding to the blind area from the composite image 603 displayed before moment t8. The electronic device may combine the obtained portion 635 with the portion 641 in the composite image 604 corresponding to the blind area. Referring to the composite image 604 of FIG. 6B, since the portion 635 of the composite image 603 is combined, at moment t8 when no image for the blind area may be obtained, the electronic device may visualize the portion 641 corresponding to the blind area. For example, the driver viewing the composite image 604 may estimate an external object included in the blind area through the visual object 680 disposed in the portion 641.

In an embodiment, a method for synthesizing images of cameras of a vehicle (e.g., a truck) including a tractor and a trailer may be required. In an embodiment, a method for providing an aerial view (or around view) according to the rotation of the trailer about the tractor may be required. In an embodiment, a method for detecting a blind area of cameras of the vehicle, caused by rotation of the trailer with respect to the tractor, may be required. In an embodiment, a method for preventing an accident caused by a blind area of cameras of the vehicle may be required. As described above, according to an embodiment, an electronic device of a vehicle may comprise memory storing instructions, a communication interface, and a processor. The instructions may, when executed by the processor, cause the electronic device to obtain first images of cameras through the communication interface. The cameras may be respectively positioned on portions of the vehicle rotatably coupled to each other. The instructions may, when executed by the processor, cause the electronic device to transmit, to the display connected through the communication interface, a first composite image which is composited to provide an aerial view of the vehicle at a first moment when the first images were obtained. The instructions may, when executed by the processor, cause the electronic device to, when synthesizing second images obtained from the cameras at a second moment after the first moment, determine, using locations of the cameras at the second moment, whether a second composite image to which the second images are composited includes a blind area. The instructions may, when executed by the processor, cause the electronic device to, based on determining that the second composite image includes the blind area, transmit, to the display, the second composite image with which a portion of the first composite image corresponding to the blind area is combined. In an embodiment, the electronic device may synthesize images from cameras of a vehicle (a truck) including a tractor and a trailer. In an embodiment, the electronic device may provide an aerial view (or around view) according to rotation of the trailer about the tractor. In an embodiment, the electronic device may detect blind areas of the vehicle's cameras caused by rotation of the trailer about the tractor. According to an embodiment, the electronic device may prevent accidents caused by blind areas of cameras of a vehicle.

For example, the instructions may, when executed by the processor, cause the electronic device to receive, from an electronic control unit (ECU) of the vehicle connected through the communication interface, information indicating a location relationship between the portions. For example, the instructions may, when executed by the processor, cause the electronic device to detect, using the information, the locations of the cameras.

For example, the instructions may, when executed by the processor, cause the electronic device to receive the information obtained using a sensor of a rotational axis of the portions respectively corresponding to a tractor and a trailer of the vehicle.

For example, the instructions may, when executed by the processor, cause the electronic device to detect, using the information including at least one of a driving direction or a driving speed of the vehicle, the locations of the cameras.

For example, the instructions may, when executed by the processor, cause the electronic device to generate the first composite image including visual objects respectively representing the portions. A location relationship between the visual objects within the first composite image may correspond to a location relationship between the portions.

For example, the instructions may, when executed by the processor, cause the electronic device to transmit, to the display, the first composite image including one or more lines representing a driving direction of the vehicle at the first moment.

For example, the instructions may, when executed by the processor, cause the electronic device to transmit, to the display, the second composite image which a visual object including a text for guiding a direction of the blind area with respect to the vehicle overlaps.

For example, the instructions may, when executed by the processor, cause the electronic device to transmit, to the display, the second composite image including a figure for highlighting the blind area.

As described above, in an embodiment, there may be provided a method of an electronic device of a vehicle. The method may comprise obtaining first images of cameras through a communication image frame. The cameras may be respectively positioned on portions of the vehicle rotatably coupled to each other. The method may comprise transmitting, to a display connected through the communication interface, a first composite image which is composited to provide an aerial view of the vehicle at a first moment when the first images were obtained. The method may comprise, when synthesizing second images obtained from the cameras at a second moment after the first moment, determining, using locations of the cameras at the second moment, whether a second composite image to which the second images are composited includes a blind area. The method may comprise, based on determining that the second composite image includes the blind area, transmitting, to the display, the second composite image with which a portion of the first composite image corresponding to the blind area is combined.

For example, the method may comprise receiving, from an electronic control unit (ECU) of the vehicle connected through the communication interface, information indicating a location relationship between the portions. The method may comprise detecting the locations of the cameras using the information.

For example, the receiving may include receiving the information obtained using a sensor of a rotational axis of the portions respectively corresponding to a tractor and a trailer of the vehicle.

For example, the method may comprise detecting, using the information including at least one of a driving direction or a driving speed of the vehicle, the locations of the cameras.

For example, the method may comprise generating the first composite image including visual objects respectively represent the portions. A location relationship between the visual objects within the first composite image may correspond to a location relationship between the portions.

For example, transmitting the first composite image may include transmitting, to the display, the first composite image including one or more lines representing a driving direction of the vehicle at the first moment.

For example, transmitting the second composite image may include transmitting, to the display, the second composite image which a visual object including a text for guiding a direction of the blind area with respect to the vehicle overlaps.

For example, the transmitting the second composite image may include transmitting, to the display, the second composite image including a figure for highlighting the blind area.

As described above, in an embodiment, there may be provided a non-transitory, computer-readable storage medium including instructions. The instructions may, when executed by a processor of an electronic device of a vehicle, cause the electronic device to obtain first images of cameras through the communication interface. The cameras may be respectively positioned on portions of the vehicle rotatably coupled to each other. The instructions may, when executed by the processor, cause the electronic device to transmit, to the display connected through the communication interface, a first composite image which is composited to provide an aerial view of the vehicle at a first moment when the first images were obtained. The instructions may, when executed by the processor, cause the electronic device to, when synthesizing second images obtained from the cameras at a second moment after the first moment, determine, using locations of the cameras at the second moment, whether a second composite image to which the second images are composited includes a blind area. The instructions may, when executed by the processor, cause the electronic device to, based on determining that the second composite image includes the blind area, transmit, to the display, the second composite image with which a portion of the first composite image corresponding to the blind area is combined.

For example, the instructions may, when executed by the processor, cause the electronic device to receive, from an electronic control unit (ECU) of the vehicle connected through the communication interface, information indicating a location relationship between the portions. For example, the instructions may, when executed by the processor, cause the electronic device to detect, using the information, the locations of the cameras.

For example, the instructions may, when executed by the processor, cause the electronic device to receive the information obtained using a sensor of a rotational axis of the portions respectively corresponding to a tractor and a trailer of the vehicle.

For example, the instructions may, when executed by the processor, cause the electronic device to detect, using the information including at least one of a driving direction or a driving speed of the vehicle, the locations of the cameras.

The above-described devices may be implemented as hardware components, software components, and/or in a combination thereof. For example, the devices and components described herein may be implemented using one or more general-purpose or specific-purpose computers, such as processors, controllers, arithmetic logic units (ALUs), digital signal processors, micro-computers, field programmable gate arrays (FPGAs), programmable logic units (PLUS), micro-processors, any other devices capable of executing and responding to instructions. The processing device or processor may perform an operating system (OS) and one or more software applications performed on the OS. The processing device or processor may access, store, manipulate or control, process, and generate data in response to the execution of the software. For illustration purposes, the processing device or processor may be a single one but it will be appreciated by one of ordinary skill in the art that a processing device may include a plurality of processing elements and/or a plurality of types of processing elements. For example, the processing device may include a plurality of processors or a single processor and a single controller. The server or device may have other various processing configurations, such as parallel processors.

The software may include computer programs, codes, instructions, or combinations of one or more thereof and may configure the processing device as it is operated as desired or may instruct the processing device independently or collectively. The software and/or data may be embodied in any type of machine, component, physical device, computer storage medium, or device so as to provide instructions or data to the processing device or to be interpreted by the processing device. The software may be distributed over computer systems connected together via a network to be distributively stored or executed. The software and data may be stored in one or more computer readable recording media.

The methods according to the embodiments may be implemented in the form of programming commands executable by various computer means, and the programming commands may be recorded in a computer-readable medium. In this case, the medium may continuously store computer-executable programs or temporarily store them for execution or download. Further, the medium may be a variety of recording or storage means in the form of a single piece of hardware or a combination of multiple pieces of hardware and, rather than being limited to a medium directly connected to a computer system, may be distributed over a network. Examples of the medium may include, but is not limited to, magnetic media, such as hard disks, floppy disks or magnetic tapes, optical recording media, such as CD-ROMs or DVDs, magneto-optical media, such as floptical disks, and ROMs, RAMs, or flash memories, or any other types of media configured to store program instructions. Further, examples of other media may include app stores that distribute applications, websites that supply or distribute various pieces of software, and recording media or storage media managed by servers.

Although the disclosure is shown and described in connection with embodiments, it will be easily appreciated by one of ordinary skill in the art that various changes or modifications may be made without departing from the scope of the disclosure. For example, although the techniques described herein are performed in a different order from those described herein and/or the components of the above-described structure or device are coupled, combined, or assembled in a different form from those described herein, or some components are replaced with other components or equivalents thereof, a proper result may be achieved.

Hence, other implementations, other embodiments, and equivalents to the claims also belong to the scope of the claims described below.

What is claimed is:

1. An electronic device of a vehicle, comprising:
memory storing instructions;
a communication interface; and
a processor,
wherein the instructions, when executed by the processor, cause the electronic device to:
obtain first images of cameras through the communication interface, wherein the cameras are respectively positioned on portions of the vehicle which are rotatably coupled to each other;
transmit, to a display connected through the communication interface, a first composite image which is composited to provide an aerial view of the vehicle at a first moment when the first images were obtained;
when synthesizing second images obtained from the cameras at a second moment after the first moment, determine, using locations of the cameras at the second moment, whether a second composite image to which the second images are composited includes a blind area; and
based on determining that the second composite image includes the blind area, transmit, to the display, the second composite image with which a portion of the first composite image corresponding to the blind area is combined.

2. The electronic device of claim 1, wherein the instructions, when executed by the processor, cause the electronic device to:
receive, from an electronic control unit (ECU) of the vehicle connected through the communication interface, information indicating a location relationship between the portions; and
detect the locations of the cameras using the information.

3. The electronic device of claim 2, wherein the instructions, when executed by the processor, cause the electronic device to:
receive the information obtained using a sensor of a rotational axis of the portions respectively corresponding to a tractor and a trailer of the vehicle.

4. The electronic device of claim 2, wherein the instructions, when executed by the processor, cause the electronic device to:
detect, using the information including at least one of a driving direction or a driving speed of the vehicle, the locations of the cameras.

5. The electronic device of claim 1, wherein the instructions, when executed by the processor, cause the electronic device to:
generate the first composite image including visual objects respectively representing the portions, and
wherein a location relationship between the visual objects within the first composite image corresponds to a location relationship between the portions.

6. The electronic device of claim 1, wherein the instructions, when executed by the processor, cause the electronic device to:
transmit, to the display, the first composite image including one or more lines representing a driving direction of the vehicle at the first moment.

7. The electronic device of claim 1, wherein the instructions, when executed by the processor, cause the electronic device to:
transmit, to the display, the second composite image which a visual object including a text for guiding a direction of the blind area with respect to the vehicle overlaps.

8. The electronic device of claim 1, wherein the instructions, when executed by the processor, cause the electronic device to:
transmit, to the display, the second composite image including a figure for highlighting the blind area.

9. A method of an electronic device of a vehicle, comprising:
obtaining first images of cameras through a communication interface, wherein the cameras are respectively positioned on portions of the vehicle which are rotatably coupled to each other;
transmitting, to a display connected through the communication interface, a first composite image which is composited to provide an aerial view of the vehicle at a first moment when the first images were obtained;
when synthesizing second images obtained from the cameras at a second moment after the first moment, determining, using locations of the cameras at the second moment, whether a second composite image to which the second images are composited includes a blind area; and
based on determining that the second composite image includes the blind area, transmitting, to the display, the second composite image with which a portion of the first composite image corresponding to the blind area is combined.

10. The method of claim 9, further comprising,
receiving, from an electronic control unit (ECU) of the vehicle connected through the communication interface, information indicating a location relationship between the portions; and
detecting the locations of the cameras using the information.

11. The method of claim 10, wherein the receiving comprises
receiving the information obtained using a sensor of a rotational axis of the portions respectively corresponding to a tractor and a trailer of the vehicle.

12. The method of claim 10, further comprising,
detecting, using the information including at least one of a driving direction or a driving speed of the vehicle, the locations of the cameras.

13. The method of claim 9, further comprising,
generating the first composite image including visual objects respectively represent the portions,
wherein a location relationship between the visual objects within the first composite image corresponds to a location relationship between the portions.

14. The method of claim 9, wherein the transmitting the first composite image comprises
transmitting, to the display, the first composite image including one or more lines representing a driving direction of the vehicle at the first moment.

15. The method of claim 9, wherein the transmitting the second composite image comprises
transmitting, to the display, the second composite image which a visual object including a text for guiding a direction of the blind area with respect to the vehicle overlaps.

16. The method of claim 9, wherein the transmitting the second composite image comprises
transmitting, to the display, the second composite image including a figure for highlighting the blind area.

17. A non-transitory, computer-readable storage medium comprising instructions, wherein the instructions, when executed by a processor of an electronic device of a vehicle, cause the electronic device to:
obtain first images of cameras through a communication interface, wherein the cameras are respectively positioned on portions of the vehicle which are rotatably coupled to each other;
transmit, to a display connected through the communication interface, a first composite image which is composited to provide an aerial view of the vehicle at a first moment when the first images were obtained;
when synthesizing second images obtained from the cameras at a second moment after the first moment, determine, using locations of the cameras at the second moment, whether a second composite image to which the second images are composited includes a blind area; and
based on determining that the second composite image includes the blind area, transmit, to the display, the second composite image with which a portion of the first composite image corresponding to the blind area is combined.

18. The non-transitory, computer-readable storage medium of claim 17, wherein the instructions, when executed by the processor, cause the electronic device to:
receive, from an electronic control unit (ECU) of the vehicle connected through the communication interface, information indicating a location relationship between the portions; and
detect the locations of the cameras using the information.

19. The non-transitory, computer-readable storage medium of claim 18, wherein the instructions, when executed by the processor, cause the electronic device to:
receive the information obtained using a sensor of a rotational axis of the portions respectively corresponding to a tractor and a trailer of the vehicle.

20. The non-transitory, computer-readable storage medium of claim 18, wherein the instructions, when executed by the processor, cause the electronic device to:
detect, using the information including at least one of a driving direction or a driving speed of the vehicle, the locations of the cameras.
